(19) United States
(12) Patent Application Publication
(10) Pub. No.: US 2012/0326413 A1
(43) Pub. Date: Dec. 27, 2012

(54) ARRANGEMENT FOR BICYCLE WITH COMBINED MOVEMENT

(76) Inventor: Felipe Rudiuk Miglorância, Sao Jose dos Campos (BR)

(21) Appl. No.: 13/516,723

(22) PCT Filed: Dec. 14, 2010
(86) PCT No.: PCT/BR2010/000438

§ 371 Date: Aug. 29, 2012

(30) Foreign Application Priority Data
Dec. 15, 2009 (BR) MU8902840-6

(51) Int. Cl. B62M 1/12

(52) U.S. Cl. 280/234

(57) ABSTRACT

“ARRANGEMENT FOR BICYCLE WITH COMBINED MOVEMENT”, consists essentially of a bicycle (1) that takes advantage its basic original structure with some possible variations of the frame (Q) the main object of which is to exercise upper members duly supported by “iron bars” (2) and respective levers (3) that describe a cyclic oblique movement, such that this movement is transformed into rotation of the front crankset (6) by means of interconnecting rods (15) with end knuckles (16) at both ends. The rotation of the front crankset (6) is then connected by a chain (5) to the conventional powering mechanism (M) of the bicycle.

This Utility Model Patent required is a new “ARRANGEMENT FOR BICYCLE WITH COMBINED MOVEMENT”, notably a bicycle that stands out for having the handlebar and respective levers with radial cyclic movements, combined with the actual bicycle pedal traction movement, in a way that the user exercises both lower and upper body members, also contributing to generate greater power for the traction wheel (aft). Thus, this equipment may be utilized for leisure or even a more refined and complete exercise workout.

Doing exercise is essential for the health and life quality of people, who live increasingly stressing daily routines. Physical exercise acts directly upon the respiratory and cardiovascular systems, releasing substances like endorphin, for example, which transcend the physical benefits towards the emotional ones. People with low self-esteem or depression who obtain an exercise-augmented endorphin production demonstrate a notable improvement in their psychological health.

To start a physical activity is not simple. First it is necessary for one to make a decision to do exercise, then the next difficulty is to choose, among many activities, that which seems most fitting to the person. The fundamental thing is to always carry an enjoyable activity, always in consonance with a healthy and balanced nutrition.

There are two modalities concerning physical exercise. One is called aerobic activity, which includes any that causes the breathing to go faster compared to when he or she is resting, raising the heart rate. There is also bodybuilding, which also helps burning the extra calories and building muscles, bones and strong joints.

Both the aerobic modality and bodybuilding may be done in gyms, however there are people that choose for the execution of body exercise in the open where, in parallel, they contemplate nature and feel the immense pleasure of feeling the freshness along tracks done by foot or upon a bicycle, for example.

Cycling is a complete, dynamic and low impact exercise, which does not bring injuries to the body, which is common in jogging, since it sustains the body weight. Basically, due to its constructive particularities, the bicycle works the legs, buttocks and stomach, not being very effective for the upper members.

For the current state-of-art, some alternate-movement bicycles or tricycles are known. They go beyond traditional movement by pedals, as can be checked in the www.streetstrider.com site where the pedals comprise a pair of platforms that have plane movements pivoted around one of the extremities, which are copied to the upper body member supporting handles, thus forcing their movement, actually being an elliptical trainer (known gym equipment) that is moveable.

Another concept of bicycle may be seen on the www.rowbike.com site, which like the model above it also proposes a more complete body workout.

In the INPI patent data bank the MU-8200418-8 was found, referring to a bicycle for rowing moved by an alternate rectilinear device. The main idea of this patent is originated in the effectiveness of the practice of rowing. Thus it is a conventional bicycle, and the novelty consists in the articulated handlebar, the actuation is done by a rack and moving cart seat.

The document above anticipates the simulation of the rowing activity, for such it has a sliding seat and rack that moves the handlebar in an angle up to 180°, thus the equipment is not appropriate for upper and lower body members in a natural way, given the position it imposes on the user.

Aware of the state of the technique, their gaps and eventual inconveniences, the inventor, after studies and research, idealized the “ARRANGEMENT FOR BICYCLE WITH COMBINED MOVEMENT” hereby described, which is stands out for its constructive simplicity and the fact that it enables one to exercise his or her muscles in an innovative way, namely, to work simultaneously the lower and upper body members. As to the upper body members, it is very different from the common bicycles, where, in these, even if a lot of strength is required from the upper body, the cycle or range of movement is relatively reduced, which hinders certain type of muscular development obtained when bigger angles are traveled. The bigger angle that the innovative bicycle allows is the one resulting from the rotation of the elbow joints, that is, the angle between arm and forearm.

Conceptually, this innovation takes advantage of the conventional movement, geometry and ergonomics of a standard bicycle, to which an additional mechanism is added, comprised of a (frontal) crankset, tied to the traction crankset through a chain, where the first mentioned crankset has rods bound to the iron arms and respective handles, that play the role of the handlebar, however with pivoted oblique movement related to the axis, this being the upper body exercise-enabling movement. Therefore, the innovation collaborated to generate more power on the bicycle's aft wheel, generating more velocity and torque, as well as reduction of travel time, when compared to the power generated only with the legs, in a common bicycle.

Another differentiating aspect in the present model resides in the possibility and ease of aggregating resources such as differentiated gears and brakes on and around the surrounding levers. Not only this, but one can even have extensions in the handlebar to act as “second option” levers, for when the rider wants to, for instance, rest the arms from the cyclic movement or need to “stand on the pedals” in an uphill or in a situation the demands bigger control of the equipment, as is normally done in a common bicycle.

Basically, the dynamics of the movement is simple, however efficient, meaning, for example, that when the right leg is at the top, ready to impulse the pedal, the user's arm of the same side (right) is about to contract the biceps when pulling the handle of the “iron arm” and the left one pushes the respective lever, generating a favorable ergonomic dynamic.

The following descriptions explain the model with reference to the annexed drawings, represented illustratively but not limited to:

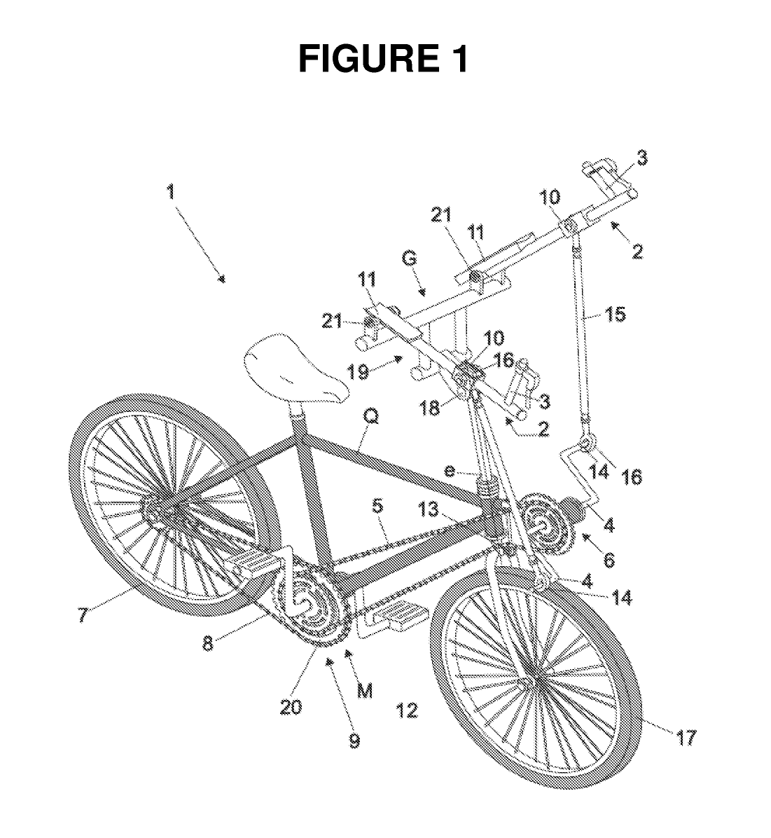

FIG. 1: Perspective view of the arrangement for bicycle with combined movement;

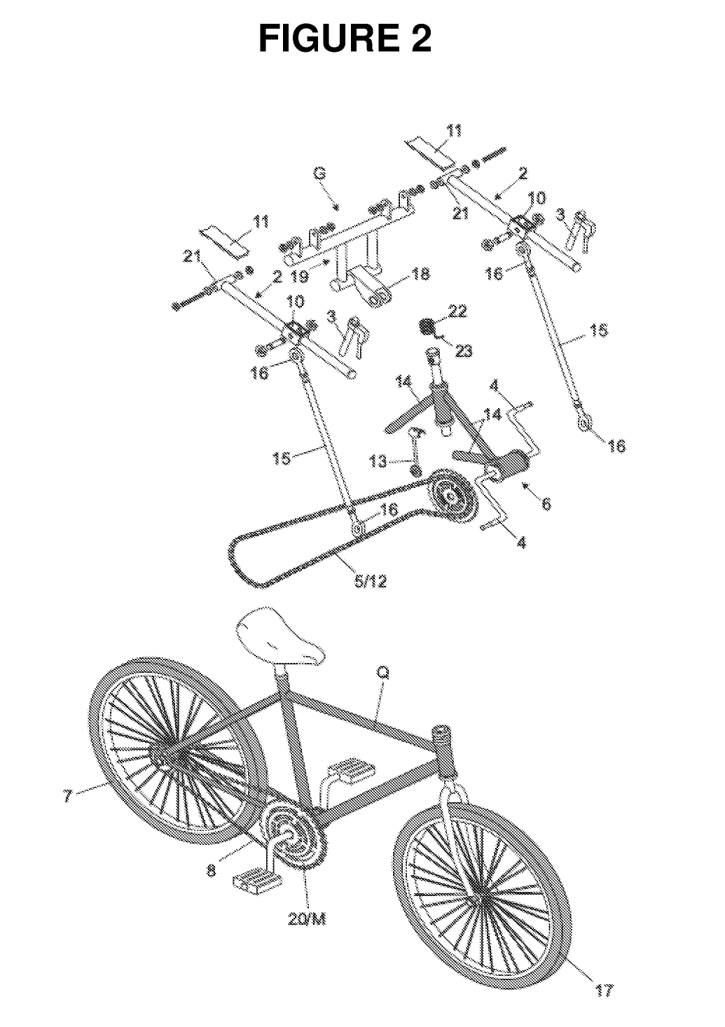

FIG. 2: Exploded perspective view of the arrangement for bicycle with combined movement;

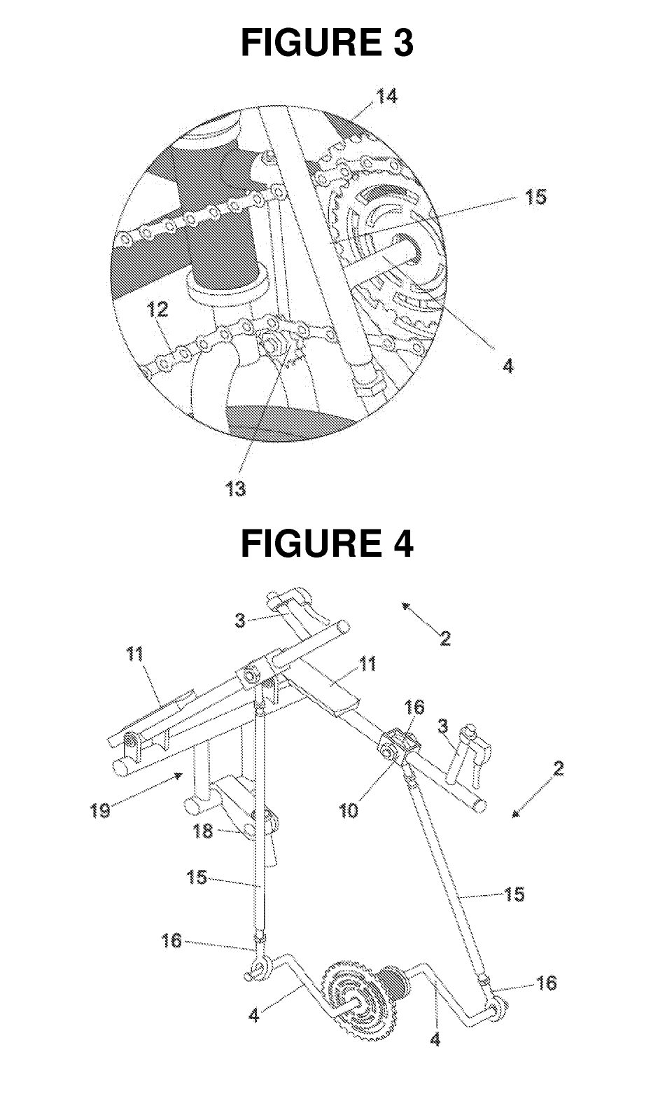

FIG. 3: Perspective detail of the front crankset chain stretcher;

FIG. 4: Perspective detail of the handlebar/iron bar;

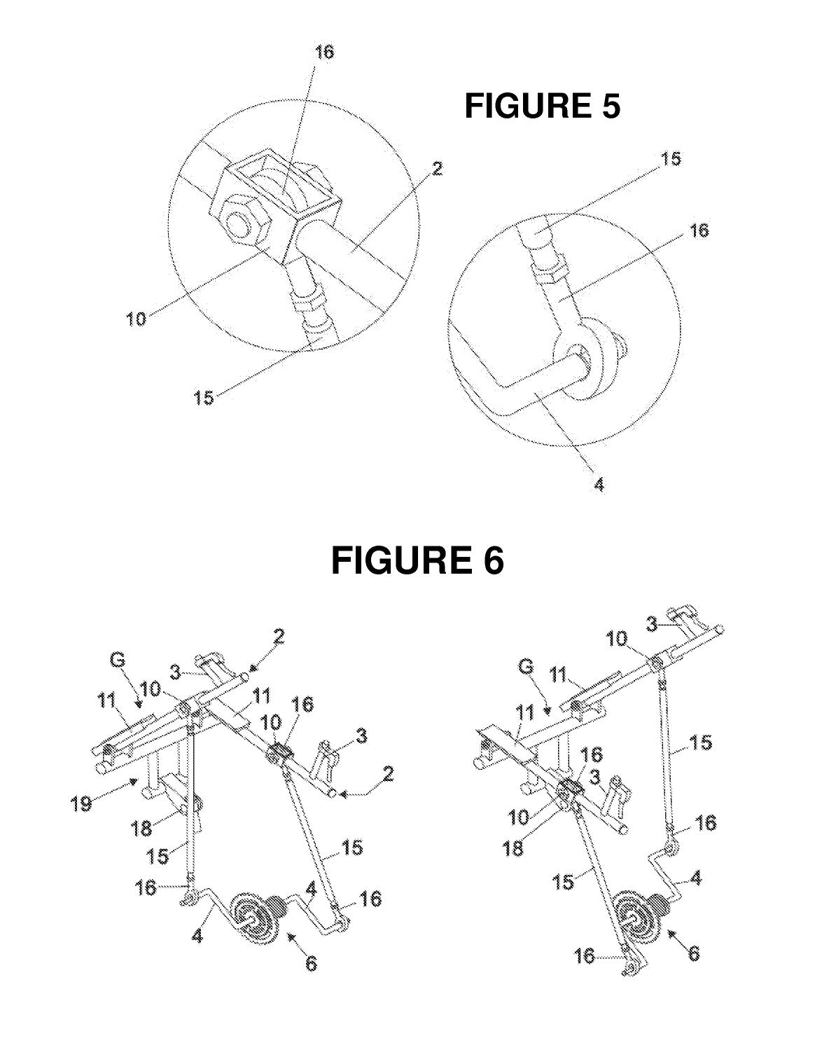

FIG. 5: Perspective detail of the handlebar hinge/iron bar;

FIG. 6: Perspective detail of the handlebar/iron bar, simulating use;

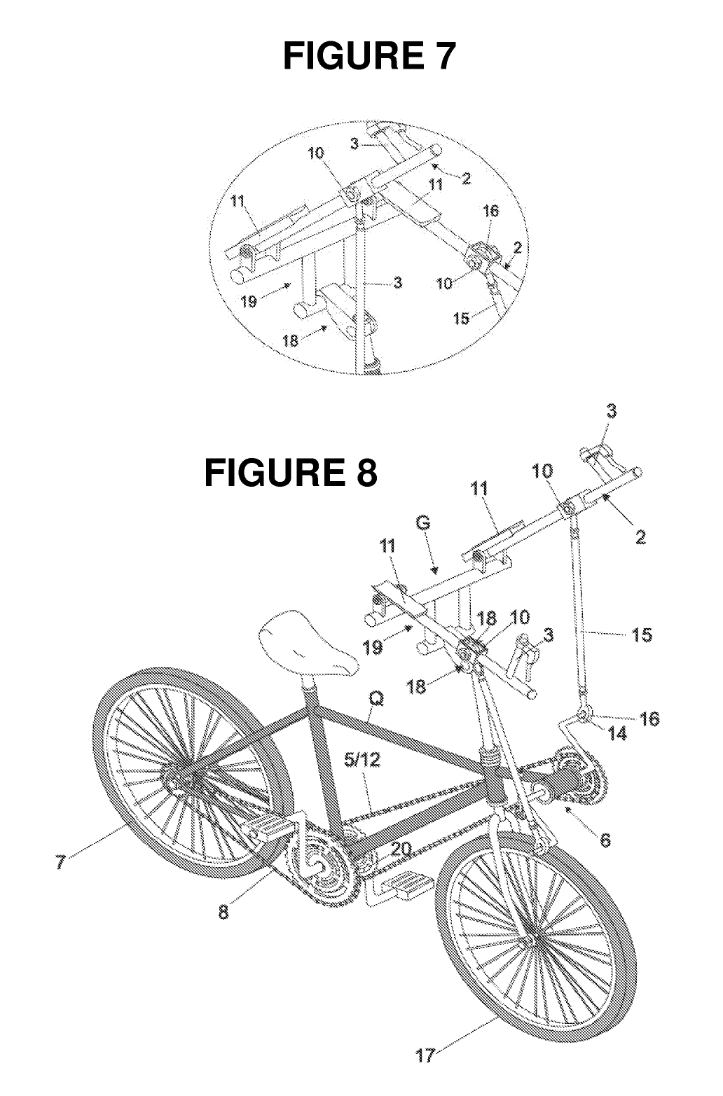

FIG. 7: Perspective detail of the handlebar/iron bar adjustments;

FIG. 8: Perspective view of the arrangement for bicycle with combined movement, in a constructive variation with the crankset chain on the left side;

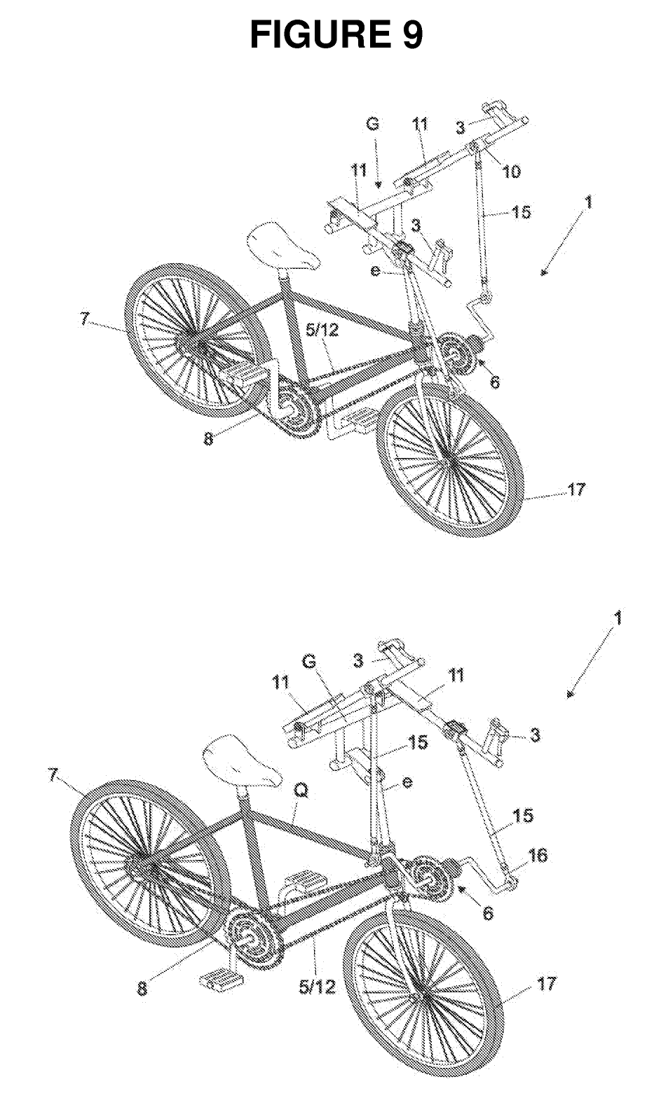

FIG. 9: Perspective view of the arrangement for bicycle with combined movement, simulating use;

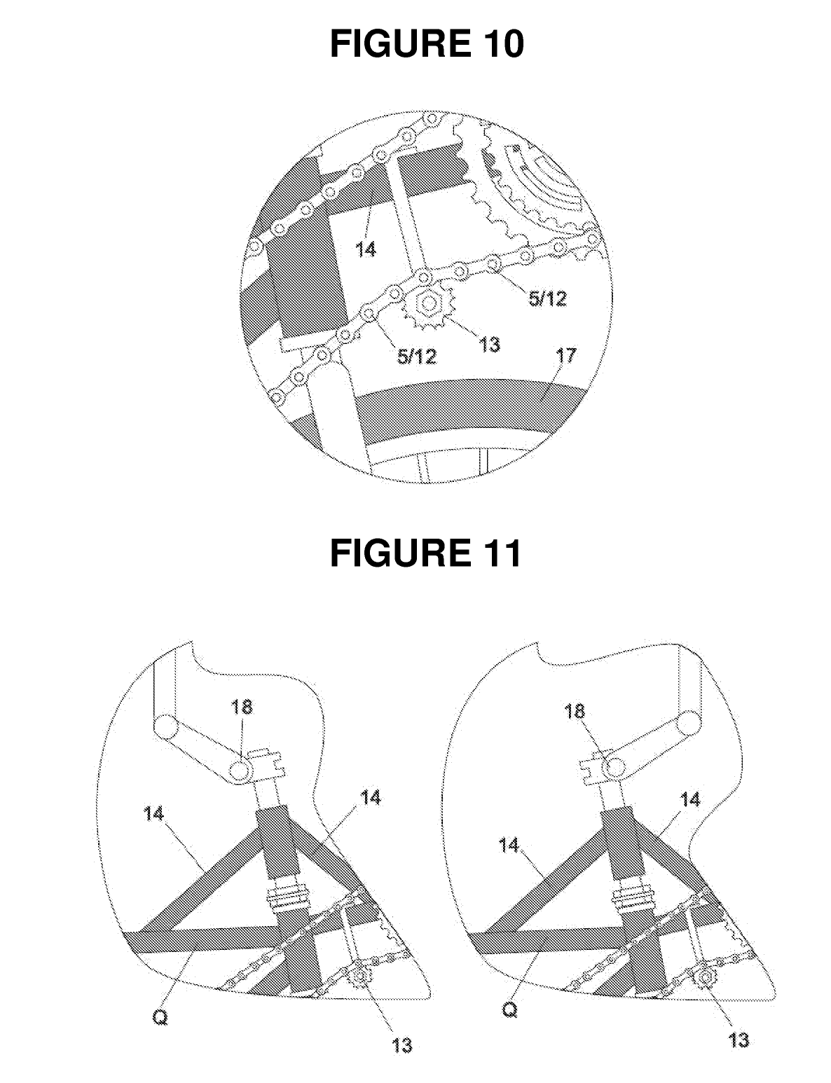

FIG. 10: Lateral detail of the optional chain stretcher and diverter;

FIG. 11: Lateral detail of the handlebar's height adjustment stem;

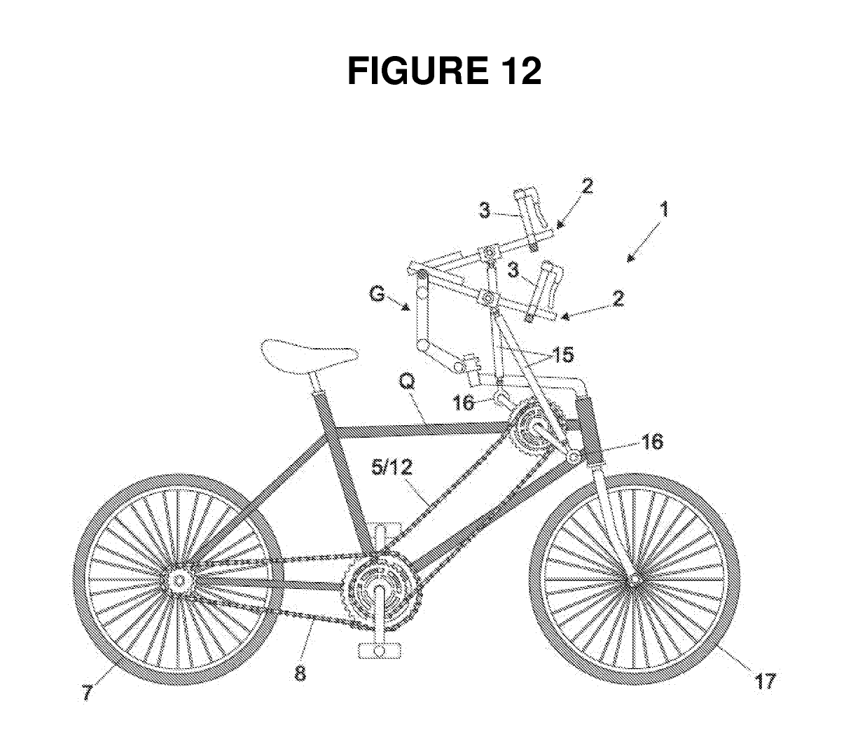

FIG. 12: Lateral view showing variations on the bicycle frame;

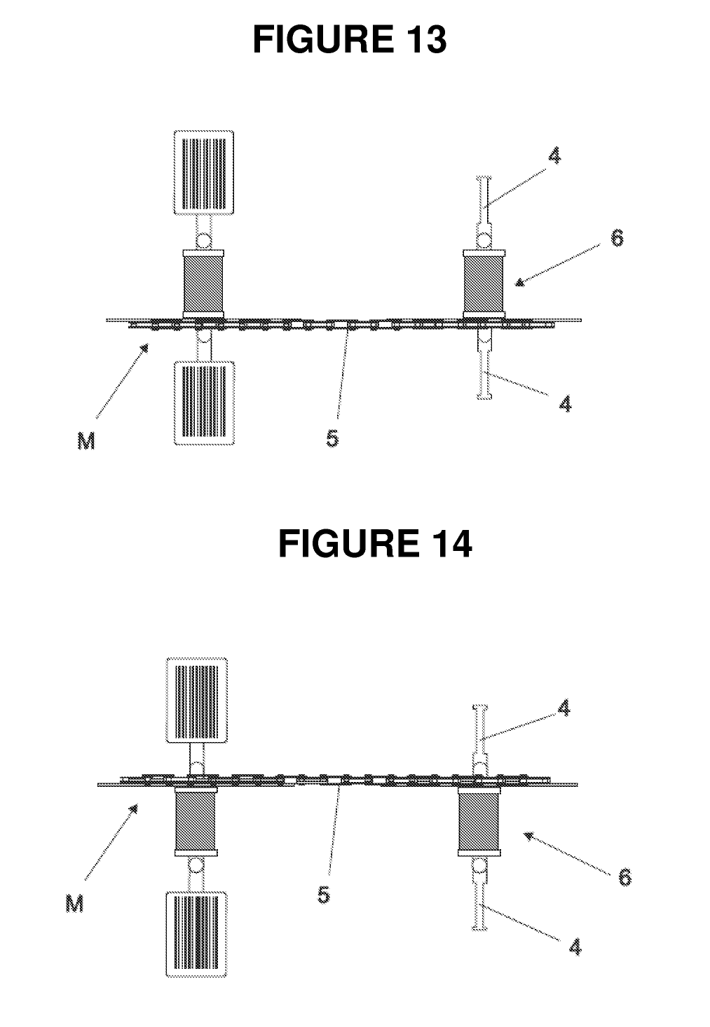

FIG. 13: Upper view of the powering mechanism positioned to the right side of the bicycle;

FIG. 14: Upper view of the powering mechanism positioned to the left side of the bicycle;

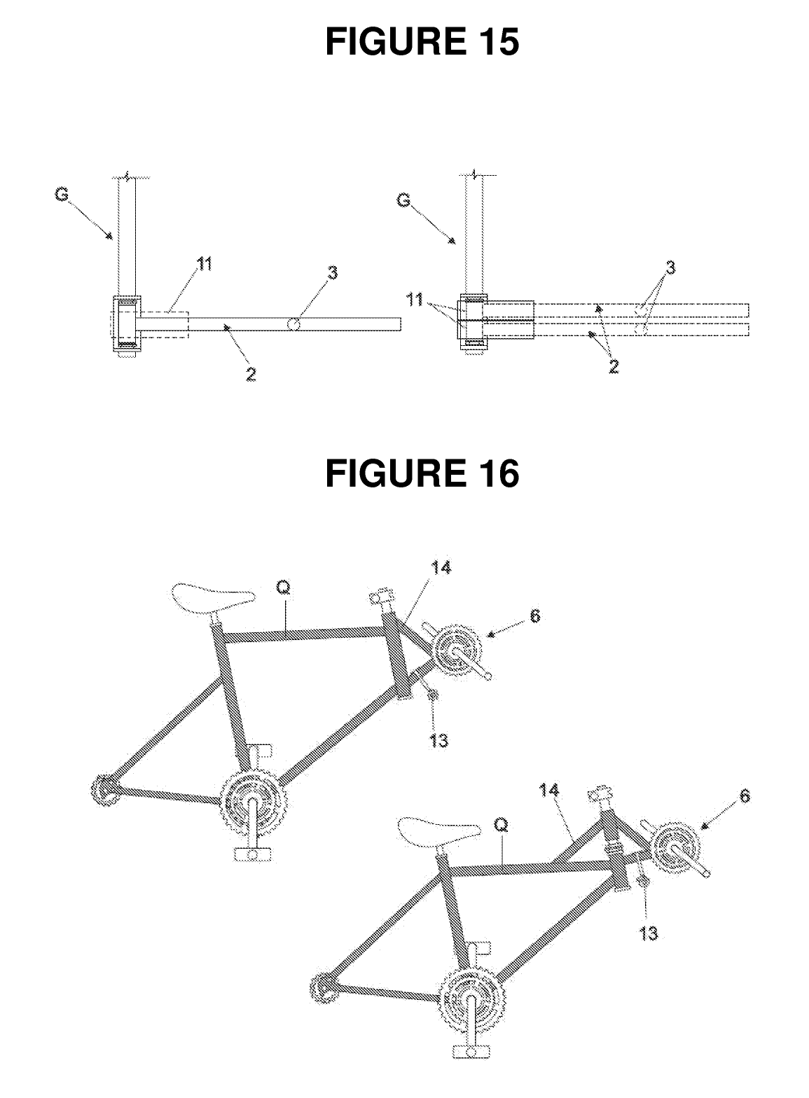

FIG. 15: Upper view of the “iron arm” showing elbow support and lever adjustments;

FIG. 16: View showing the possibilities of bicycle frame positioning;

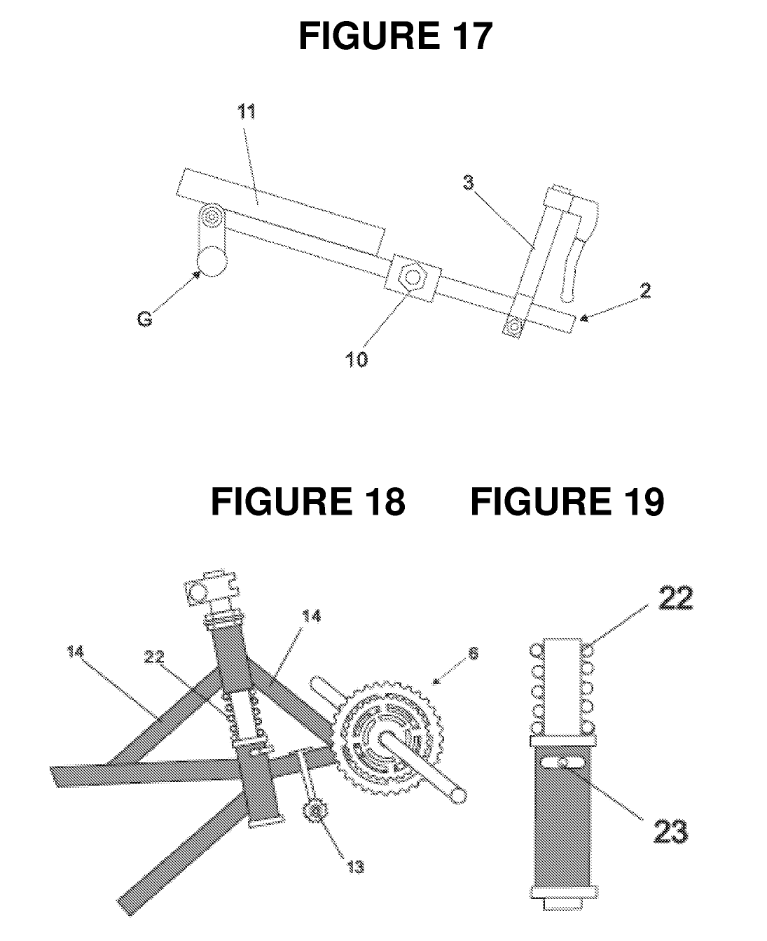

FIG. 17: Lateral view detail of the “iron arm” and elbow support;

FIG. 18: Detail showing the possibility of the torsion spring for more steering stability and the limiting pin for maximum steering angle;

FIG. 19: Elevation detail of the handlebar's spinning point with torsion spring and limiting pin.

The “ARRANGEMENT FOR BICYCLE WITH COMBINED MOVEMENT”, object of this Utility Model Patent request consists essentially of a bicycle (1) that takes advantage its basic original structure, although there may be some variations on the frame (Q), which stands out for enabling the exercise of the upper members duly supported on the “iron arms” (2) and respective levers (3) that make up oblique cyclic movement, combined with the powering pedal (4) movement through the chain (5) that links it to the front crankset (6).

The model hereby pleaded takes advantage of the basic structure of a conventional bicycle, that is, the frame (Q), rear wheel (7), chain (8) and pedal (4) without mischaracterizing the standard movement, ergonomics and geometry of this type of vehicle.

More particularly, the innovative bicycle (1) has the handlebar (G) comprised of “iron arms” (2) pivoted (α) in the supports (10), enabling cyclic and oblique movement, copying such movement to the upper members, in synchrony with the leg's movement, once the elbow leans duly on the fore support (11) and the hands on the respective levers (3) of the actual “iron arm” (2). Therefore, the pivoting point of the “iron arm” (2) coincides with the rotation axle (E) of the elbow support (11) once the bearings are common. The synchrony of the referred movements occurs by a front crankset (6) that acts as a “crank”, linked through the chain (5) with optional stretcher (13) to the rear wheel (7) powering mechanism (M). From the front pedal (6) orthogonal projections (14) are derived, which extremities receive rods (15) with ball or knuckle joints (16), which allow for rotating movement, with the translation limitation concerning the “iron arms” (2), in which middle sections the same model of joints are allocated (16). This way, one can spin the handlebar (G) and the front wheel (17) without interfering with the front crankset (6) movement and respective chain (5).

The knuckle (16) joints may be substituted by other kinds of joints that promote the same effect of allowing the rotation and limiting the translation.

Above the rotation point (18) and handlebar (G) a stem is projected (19) that can be articulated (β), in this case allowing for height adjustment of the called handlebar (G). The handlebar itself (G) may be constructed in a way that it be combined with the stem (19) hinge so that it could regulate/calibrate its height, so that it be adjusted to the best user elbow's position.

The innovation may be applied in different constructive configurations of frames (Q) and handlebars (G).

The conventional powering mechanism (M) formed by chain rings (20), pedal (4) and chain (8) is positioned at the right side, however the mechanism that will transfer power to the front crankset (6), which supports the front chain (5) may be established to the left. For such, Chain rings (20) should be added on the left side, both in the conventional crankset mechanism (M) as on the front crankset (6), in this latter only the chain ring on the left side.

The “metal arm” may present a sliding device (21) in the respective axles which promote the transversal adjustment of the elbow support (11) and lever (3).

The frame (Q) may be altered concerning the positioning between the rotation point (18) and the crankset (16) in advanced or drawn back position.

Finally, the rotation point (18) of the handlebar (G) or any section related to it may present a torsion spring (22), with the goal of limiting stabilizing the steering movement, always assuring the return to neutral position. On the other hand, there may be pins (23), locks or limiters inserted on the parts related to the rotation point (18) which limit the maximum steering angle.

The concept here pleaded may be utilized on stationary and static bicycles and mechanisms for HPA (Human Powered Aircraft), and similar products.

1) “ARRANGEMENT FOR BICYCLE WITH COMBINED MOVEMENT”, takes advantage of a conventional bicycle, that is, the frame (Q), forward (17) and aft (7) wheel, chainrings (20), chain (8) and pedal (4) without mischaracterizing the standard movement, ergonomics and geometry of this type of vehicle; characterized for presenting a handlebar (G) made up of “iron arms” (2) pivoted (α) around the supports (10), as to enable a cyclic and oblique movement; the elbow is duly held in the fore support (11) and the hands hold the respective levers (3) of the “iron arms” (2); the rotating axis of the “iron arms” (2) coincides with the elbow support (11) rotating axis (E) once the rotating bearings (R) are common; the synchrony of the movements occurs by a front crankset (6) interlinked through a chain (5) with optional stretcher/diverter (13) in the chain's inferior and/or superior section, to the powering pedal (4) of the aft (7) wheel; from the front crankset (6) orthogonal projections are derived, on the extremities of which rods (16) with knuckle joints (16) are placed, allowing for rotational movement whilst limiting translation; the “iron arms” (2) in their middle portions are allocated with the same model of joints (16); the knuckle joints (16) may be substituted by other types of joints that promote the same effect of allowing rotation and limiting translation; above the rotating point (18) and the handlebars (G) an articulated (β) stem (19) is projected, which enables the height adjustment of the called handlebar (G); the bicycle (1) powering mechanism (M) is normally positioned on the right side, however the front mechanism may be established to the left side, for such on this side there will need to be a chain rings (20), also on the front crankset (6); the “iron arm” may present a sliding device (21) on the respective axles, that promote transversal adjustment of the elbow support (11) and lever (3); the handlebar (G) rotating point (18) may present, on some location along its extension, a torsion spring (22), pins (23), locks or limiters inserted on the rotation point (18).
